(19) United States
(12) Patent Application Publication
(10) Pub. No.: US 2003/0040223 A1
(43) Pub. Date: Feb. 27, 2003

(54) Telephone adapter

(76) Inventor: Richard Drewnicki, Peterborough (GB)

Correspondence Address: Darin J Gibby, Townsend and Townsend and Crew, Two Embarcadero Center 8th Floor, San Francisco, CA, 94111, US

(21) Appl. No.: 10/149,934

(22) PCT Filed: Dec. 15, 2000
(86) PCT No.: PCT/GB00/04822

(51) Int. Cl. H01R 25/00

(52) U.S. Cl. 439/638

(57) ABSTRACT

A telephone adapter (10, 20) for use with a telephone plug (21) having at least one male member (25) and a telephone socket (23), the plug and socket, so that a telephone plug (21) can be mounted in a telephone socket (23) with the adapter (10, 20) therebetween, the at least one male member (25) of the telephone plug (21) passing through the at least one hole (3) of the adapter into the telephone socket to support the telephone adapter and to connect the telephone plug (27) or socket (5) of the second standard to the socket of the first standard via the interconnections, the contacts and the male member of the plug.

### DESCRIPTION

### FIELD OF THE INVENTION

The invention relates to a telephone adapter, particularly a telephone adapter for converting between one telephone standard and another.

### BACKGROUND TO THE INVENTION

Telephone plugs and sockets come in a variety of different standards, indeed, most countries have their own standard for telephone plugs and sockets.

However, increased international travel and the use of modems, portable fax machines and the like have resulted in an ever increasing need to use equipment with a plug or socket corresponding to one standard at locations where the supplied plug or socket has a different standard. In particular, international travellers may wish to plug their computer into local telephone outlets in countries other than their own.

To meet this need, a number of telephone adapters are available to convert between various standards of equipment. However, it is generally necessary to have one adapter for each telephone standard. Moreover, the plugs and sockets required by some telephone standards can be extremely bulky. The requirement for an international traveller to carry a large number of bulky adapters can be very inconvenient.

Accordingly, there is a need for a smaller and lighter adapter.

### SUMMARY OF THE INVENTION

According to the invention, there is provided a telephone adapter for use with a telephone plug having at least one male member and a telephone socket, the plug and socket corresponding to a first standard, the telephone adapter comprising a substrate, at least one hole passing through the substrate for receiving the at least one male member of the telephone plug, a plurality of contacts for electrically contacting the at least one male member of the telephone plug when received in the at least one hole, a telephone plug or socket corresponding to a second standard, and interconnections on the substrate connecting the contacts to the plug or socket of the second standard, so that a telephone plug can be mounted in a telephone socket with the adapter therebetween, the at least one male member of the telephone plug passing through the at least one hole of the adapter into the telephone socket to support the telephone adapter and to connect the telephone plug or socket of the second standard to the socket of the first standard via the interconnections, the contacts and the male member of the plug.

Because the adapter according to the present invention uses the male member of a telephone plug that already exists rather than needing its own male member, it can be considerably smaller and especially thinner than a telephone adapter having its own male member or members. The substrate may be less than 3 mm thick, or even 2 mm or preferably 1 mm.

Of course, the approach used does require that there be a telephone plug available locally when it is required to use the adapter. However, in general there will be a telephone plug for existing equipment at locations where there is a telephone socket. Accordingly, this requirement should not create any difficulty.

The second standard may be different to the first standard, so that the telephone adapter can be used to convert between one standard and another. Alternatively, the first and second standards can be the same, the telephone adapter then allowing two telephone plugs to be associated with a single socket.

In embodiments, the at least one male member of the telephone plug comprises a plurality of pins. Such telephone plugs are in use in many countries of the world.

The adapter may comprise a plurality of holes corresponding to the holes of a socket of the first standard, in order to accept a telephone plug of that first standard. Alternatively, a different arrangement or number of holes may be used—for example one large hole could contain two contacts for separate connection to two pins.

In addition to a plurality of holes and a plurality of contacts corresponding to a first standard, the telephone adapter may further comprise a plurality of holes and a plurality of contacts corresponding to a third, fourth or any number of standards. Accordingly, the telephone adapter of the present invention may be useful in providing a compact telephone adapter which can be used with many different standards.

Preferably, the telephone plug or socket of the second standard can be folded down for storage. This may be an RJ11 socket, which corresponds to interconnections widely found in computer equipment.

The substrate may be of injection moulded plastics. The interconnections can be wires moulded into the plastics. Alternatively, the substrate may comprise a base plate on or in which the interconnections or wires are supported and an upper plate which covers the wires. Both the base and upper plates are preferably formed with holes which are aligned when the plates are brought into contact. The base plate may be formed with a recess in which the upper plate sits.

The plurality of contacts may comprise the ends of the wires. This may be achieved by providing a wire form comprising a plurality of wires forming the interconnections, placing the wire form into the injection mould, and moulding the plastics around the wire form to manufacture the telephone adapter.

In addition to the use of plastics, the substrate may be paper or a printed circuit. Promotional messages may be printed on the substrate.

A brief description of the drawings for a better understanding of the invention, an embodiment of it will now be described, purely by way of example, with reference to the accompanying drawings in which

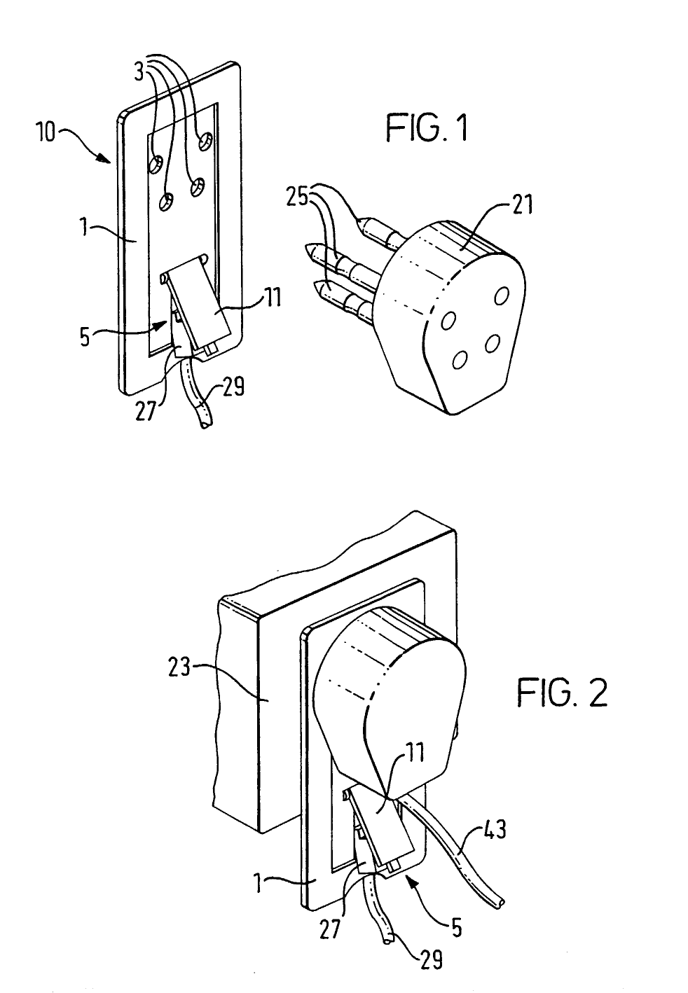

FIG. 1 is a front perspective view of a first telephone adapter according to the present invention with a plug adjacent the adapter,

FIG. 2 is a view of the adapter of FIG. 1 in use,

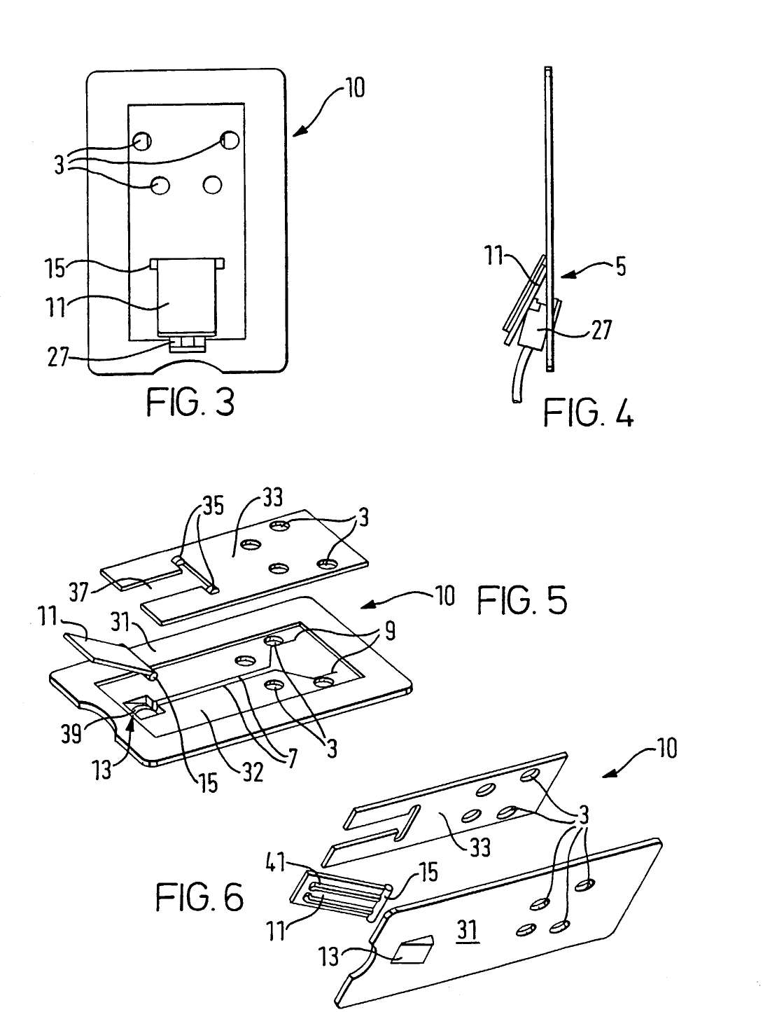

FIG. 3 is a front view of the adapter of FIG. 1 with a RJ11 plug in place,

FIG. 4 shows a front view of the adapter of FIG. 3,

FIG. 5 is an exploded plan perspective view of the adapter of FIG. 1,

FIG. 6 is an underside perspective view of the adapter of FIG. 1,

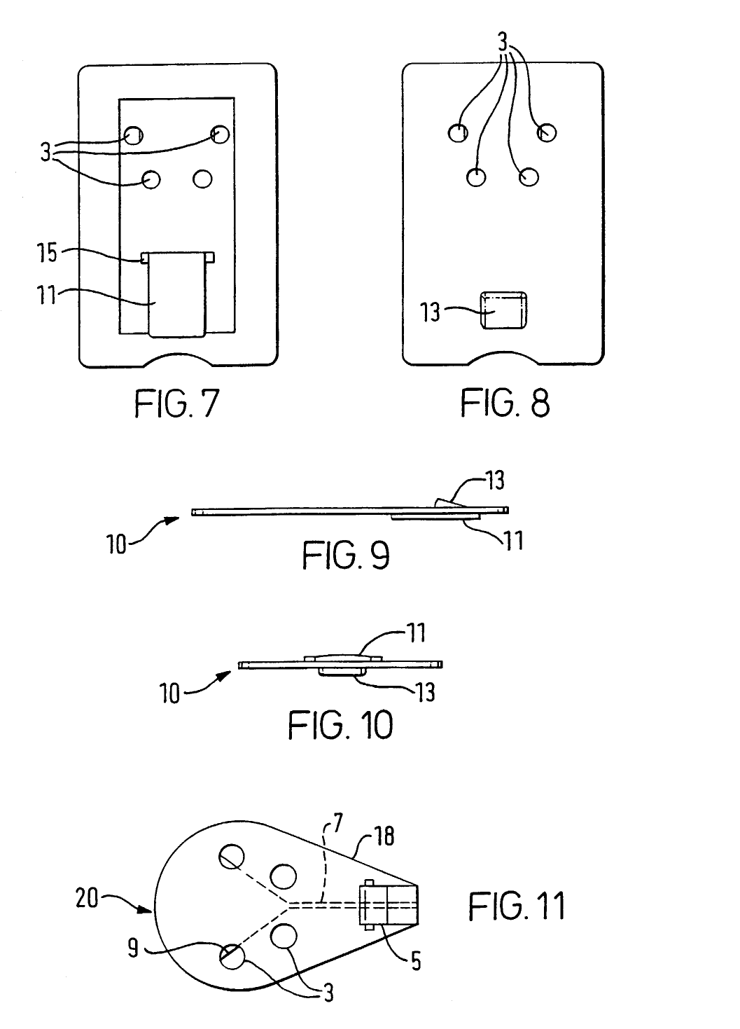

FIG. 7 is a front view of the adapter of FIG. 1 without a RJ11 plug,

FIGS. 8, 9 and 10 show respective rear, side and top views of the adapter of FIG. 7, and

FIG. 11 is a front perspective view of a second telephone adapter according to the present invention.

### DETAILED DESCRIPTION

FIGS. 1 to 11 show two telephone adapters 10, 20 designed for converting between Dutch telephone connections and an RJ11 connection, widely used in the United States.

Referring to FIGS. 1 to 10, the adapter 10 comprises a generally flat plastics substrate 1 having a group of holes 3 passing through the substrate normally to its plane. The pattern of the group of holes 3 matches the pattern of a group of pins in a corresponding plug. An RJ11 socket 5 is provided at one end of the substrate 1.

Referring to FIGS. 1 and 2, in use, the telephone adapter is mounted between a Dutch plug 21 and a corresponding Dutch wall socket 23. The pins 25 of the Dutch plug 21 pass through the holes 3 of the telephone adapter into the wall socket. The Dutch plug has four pins 25 and hence the substrate 1 has four holes 3. The adapter is accordingly held in place, the plug engaging in the wall socket. The substrate 1 is sufficiently thin that contact is still made between the pins 25 and wall socket 23. An RJ11 plug 27 1s mounted into the socket 5 to make contact to it.

As shown in FIGS. 5 and 6, the substrate 1 is formed from a base plate 31 and an upper plate 33. The base plate 31 is generally flat and rectangular with a shallow rectangular recess 32 into which the upper plate 33 fits. Both the upper plate 33 and base plate 31 are formed with holes 3 which are aligned when the plates are in contact.

The RJ11 socket 5 comprises a top part 11 and a bottom part 13. The bottom part 11 is fixed into the base plate 31 and the top part 11 is hinged to hinge mountings 35 on the upper plate 33. The top part is thus pivotable along a hinge 15 so that the socket can be folded down for storage. The top part 11 is generally flap-like. Upper plate 33 is formed with a slot 37 to allow movement of the top part 11 of the socket 5.

A plurality of wires 7 are mounted on the base plate 31 and run between the RJ11 socket 5 and the holes 3. One end of each wire forms an electrical contact 9 in the holes 3 and the opposed end of each wire forms an electrical contact 39 in the bottom part of the RJ11 socket 5. The top part 11 of the RJ11 socket 5 also carries electrical contacts 41.

Thus, in use, an RJ11 plug 27 mounted in the socket 5, is connected via the electrical contacts 39 through the wires 7 to the contacts 9. The contacts 9 are contacted by the pins 25 of the Dutch plug and thus the RJ11 plug 27 is connected into the wall socket through the pins 25. Accordingly, a lead 29 attached to the RJ11 plug 27 is connected to the wall socket. A lead 43 attached to the plug 21 is also attached to the wall socket 23.

FIG. 11 shows an alternative adapter 20 which has the same functionality of the adapter of FIGS. 1 to 10 and thus all features in common have the same reference number. In contrast to the adapter 10 of FIG. 1, the alternative adapter 20 has a generally flat plastics substrate 1 having a generally egg-shaped cross-section. The alternative adapter 20 comprises a generally flat plastics substrate 18 having a plurality of holes 3 passing through the substrate normally to its plane An RJ11 socket 5 is provided at one end of the substrate 1 which is connected via wires 7 to contacts 9 in the holes 3. In this embodiment, the wires 7 are embedded in the substrate 18 which is formed from a single piece.

### INDUSTRIAL APPLICABILITY

The required telephone adapter is thus provided in a convenient, thin form.

1. A telephone adapter (10, 20) for use with a telephone plug (21) having at least two male members (25) when coupled with a telephone socket (23), the plug and socket corresponding to a first standard, the telephone adapter comprising a substrate (1), at least two holes (3) passing through the substrate for receiving the at least two male members (25) of the telephone plug (21), at least two electrical contacts (9) on the substrate (1) for electrically contacting the at least two male members (25) of the telephone plug when received in the at least two holes (3), a telephone plug (27) or socket (5) corresponding to a second standard mounted on or associated with the substrate (1), and interconnections (7) mounted on or embedded in the substrate connecting each contact (9) to the plug (27) or socket (s) of the second standard, so that a telephone plug (21) of the first standard can be mounted in a telephone socket (23) of the first standard with the adapter (10, 20) sandwiched therebetween, the at least two male members (25) of the telephone plug of the first standard passing through the at least two holes (3) of the adapter into the telephone socket (23) to support the telephone adapter (10,20) and to connect the telephone plug (27) or socket (5) of the second standard to the socket (23) of the first standard via the interconnections (7), the contacts (9) and the male members of the telephone plug (21) of the first standard.

2. A telephone adapter according to claim 1, wherein the substrate (1) is plate-like.

3. A telephone adapter according to claim 1 or claim 2, wherein the second standard is different to the first standard, so that the telephone adapter can be used to convert between one standard and another.

4. A telephone adapter according to any one of claims 1 to 3, wherein the substrate (1) further comprises a plurality of holes (3) and a plurality of contacts corresponding to at least a third standard.

5. A telephone adapter according to any preceding claim, wherein the telephone plug (27) or socket (5) of the second standard is foldable for storage.

6. A telephone adapter according to any preceding claim, wherein the substrate (1) is of injection moulded plastics.

7. A telephone adapter according to claim 6, wherein the interconnections are wires (7) moulded into the plastics.

8. A telephone adapter according to claim 7, wherein the or each contact (9) comprises an end of the wire.

9. A telephone adapter according to any one of claims 1 to 6, wherein the substrate (1) comprises a base plate (31) which supports the interconnections and an upper plate (33) which covers the interconnections.

10. A telephone adapter according to claim 9, wherein the base plate (31) is formed with a shallow recess (32) into which the upper plate fits
